(19) United States
(12) Patent Application Publication
(10) Pub. No.: US 2024/0346642 A1
(43) Pub. Date: Oct. 17, 2024

(54) AUTOMATICALLY DETERMINING INTERNAL STATE INFORMATION FOR DEVICES USING ARTIFICIAL INTELLIGENCE TECHNIQUES

(71) Applicant: Dell Products L.P., Round Rock, TX (US)

(72) Inventors: Parminder Singh Sethi, Punjab (IN); Atishay Jain, Meerut (IN); Lakshmi Saroja Nalam, Bangalore (IN)

(21) Appl. No.: 18/135,326

(22) Filed: Apr. 17, 2023

(51) Int. Cl. G06T 7/00; G06T 7/70; G06V 10/25; G06V 10/44; G06V 10/74; G06V 10/764

(52) U.S. Cl. CPC G06T 7/001; G06T 7/70; G06V 10/25; G06V 10/44; G06V 10/761; G06V 10/764; G06T 2207/10116; G06T 2207/20081; G06T 2207/20084; G06V 2201/07

(57) ABSTRACT

Methods, apparatus, and processor-readable storage media for automatically determining internal state information for devices using artificial intelligence techniques are provided herein. An example computer-implemented method includes identifying one or more objects in image data associated with at least one device by processing at least a portion of the image data using one or more artificial intelligence techniques; performing a comparison of at least a portion of the one or more identified objects to a predetermined set of one or more objects associated with the at least one device; determining internal state information attributed to the at least one device based at least in part on results of the comparison; and performing one or more automated actions based at least in part on the internal state information.

### FIELD

The field relates generally to information processing systems, and more particularly to techniques for processing device-related data in such systems.

### BACKGROUND

Commonly various devices (e.g., laptops, servers, peripherals, etc.) can be shipped to users and returned for one or more reasons. Upon receiving a returned device, the health and/or working state of the device is likely unknown to the receiving entity (e.g., a manufacturer). Further, for a returned device, for example, wherein the operating system is not loading due to one or more component failures and/or issues, conventional device management approaches typically involve manual device diagnostic efforts, which are resource-intensive and error-prone.

### SUMMARY

Illustrative embodiments of the disclosure provide techniques for automatically determining internal state information for devices using artificial intelligence techniques.

An exemplary computer-implemented method includes identifying one or more objects in image data associated with at least one device by processing at least a portion of the image data using one or more artificial intelligence techniques, and performing a comparison of at least a portion of the one or more identified objects to a predetermined set of one or more objects associated with the at least one device. The method also includes determining internal state information attributed to the at least one device based at least in part on results of the comparison, and performing one or more automated actions based at least in part on the internal state information.

Illustrative embodiments can provide significant advantages relative to conventional device management approaches. For example, problems associated with resource-intensive and error-prone efforts are overcome in one or more embodiments through automatically determining internal state information for devices using one or more artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically determining internal state information for devices using artificial intelligence techniques in an illustrative embodiment.

FIG. 2 shows example architecture in an illustrative embodiment.

FIG. 3 shows an example region-based convolutional neural network (R-CNN) workflow in an illustrative embodiment.

FIG. 4 shows an example table representing device component identification results in an illustrative embodiment.

FIG. 5 is a flow diagram of a process for automatically determining internal state information for devices using artificial intelligence techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

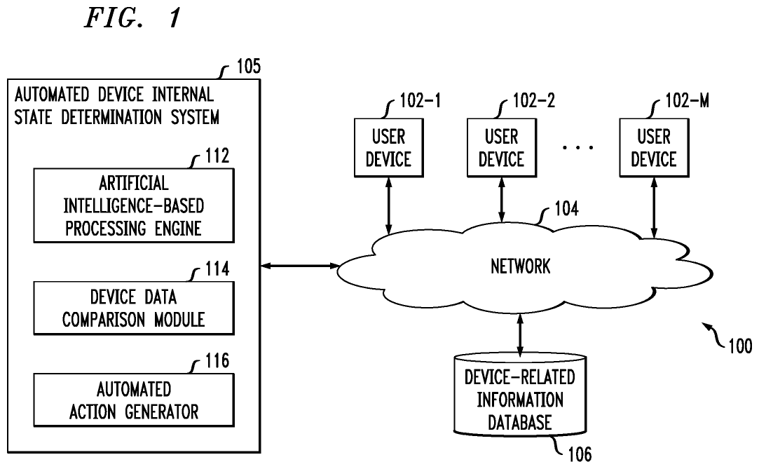

FIG. 1 shows a computer network (also referred to herein as an information processing system) 100 configured in accordance with an illustrative embodiment. The computer network 100 comprises a plurality of user devices 102-1, 102-2, 102-3, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated device internal state determination system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.” Additionally, in one or more embodiments, user devices 102 may also comprise imaging devices (e.g., one or more X-ray scanners), as further detailed herein.

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated device internal state determination system 105 can have an associated device-related information database 106 configured to store data pertaining to device-related information such as pre-shipping device information (e.g., internal state information such as componentry, circuitry, etc. of various devices before being shipped to users).

The device-related information database 106 in the present embodiment is implemented using one or more storage systems associated with automated device internal state determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated device internal state determination system 105 are one or more input-output devices, which illustratively comprise keyboards, displays or other types of input-output devices in any combination. Such input-output devices can be used, for example, to support one or more user interfaces to automated device internal state determination system 105, as well as to support communication between automated device internal state determination system 105 and other related systems and devices not explicitly shown.

Additionally, automated device internal state determination system 105 in the FIG. 1 embodiment is assumed to be implemented using at least one processing device. Each such processing device generally comprises at least one processor and an associated memory, and implements one or more functional modules for controlling certain features of automated device internal state determination system 105.

More particularly, automated device internal state determination system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated device internal state determination system 105 to communicate over the network 104 with the user devices 102, and illustratively comprises one or more conventional transceivers.

The automated device internal state determination system 105 further comprises artificial intelligence-based processing engine 112, device data comparison module 114, and automated action generator 116.

It is to be appreciated that this particular arrangement of elements 112, 114 and 116 illustrated in automated device internal state determination system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically determining internal state information for devices using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated device internal state determination system 105 and device-related information database 106 can be on and/or part of the same processing platform.

An exemplary process utilizing elements 112, 114 and 116 of an example automated device internal state determination system 105 in computer network 100 will be described in more detail with reference to the flow diagram of FIG. 5.

Accordingly, at least one embodiment includes automatically determining internal state information for devices (e.g., devices in powered-off states) using artificial intelligence techniques. As further detailed herein, such an embodiment includes determining state information for one or more devices (e.g., devices which were shipped back from one or more users to one or more receiving entities (e.g., manufacturers)) to proactively identify any missing components and/or faulty connections. This can be achieved, for example, by generating a device data listing for a given received device using one or more imaging devices (e.g., X-ray scanners, ultrasound scanners, computerized tomography (CT) scanners, magnetic resonance imaging scanners, etc.) and one or more deep learning models such as, for example, one or more R-CNNs. Additionally, at least one embodiment can include determining at least one root cause of at least one issue using such a device data listing, as well as generating at least one recommendation (and outputting the at least one recommendation to personnel (e.g., an engineer) associated with the receiving entity) based at least in part on the identified root cause(s) for the issue(s).

Accordingly, one or more embodiments include using one or more imaging devices (e.g., one or more X-ray scanners) to scan a received device and generate a two dimensional (2D) digital image of the device. This image is then fed to and/or processed by at least one deep learning model which performs object identification and/or image classification to identify and/or determine one or more internal components and/or circuitry of the device. In at least one embodiment, and as further detailed herein, the at least one deep learning model includes at least one trained R-CNN.

Once the object identification is performed by the at least one deep learning model, the component(s) and/or circuitry identified for the device are compared with device data of the device before the device was sent to the user and/or original/as-shipped device data of the same device type. Through such comparison, at least one root cause of at least one device issue can be identified, and at least one recommendation can be generated and sent to at least one receiving entity agent and/or associated system.

Accordingly, one or more embodiments include preparing and/or training at least one deep learning model (e.g., an R-CNN) which can be used for image classification and/or object recognition. Such a model can be trained, for example, using data derived from devices which are to be shipped to users. By way merely of illustration, such deep learning model training can be carried out as follows. X-ray scanning, by way merely of example, can be used to scan the devices to generate 2D image data of the internal components of the devices, and at least a portion of the 2D image data is supplied to the deep learning model to be trained. Once the deep learning model is trained, the deep learning model can be used to process image data derived from devices shipped to users and/or returned by users.

In accordance with one or more embodiments, using such a trained deep learning model (e.g., a trained R-CNN) can include the following set of example steps. A given device is received back from a user (e.g., due to a shipment-related issue and/or device-related issue), and X-ray scanning techniques are used to scan and/or process at least a portion of the received device. Once the X-ray image data is generated and/or obtained, the trained deep learning model performs object identification by processing at least a portion of the image data. Such object identification can be leveraged to determine and/or generate a device data listing which can be used (e.g., by comparing to a default device data listing for the device and/or device type in question) to identify if there are any missing components, faulty components, misplaced components, broken links, damaged components, damaged and/or misplaced component labels, etc.

By way merely of illustration, consider the following example use case. Before shipping a device to a user, the pre-ship device data contains information about the hardware components present in the device before shipping (e.g., hard drive(s), memory component(s), fan(s), etc.). Further, for the purposes of this example, assume that during transit, the hard drive spindle of the device is damaged, and the device is subsequently shipped back to the receiving entity (e.g., the manufacturer) by the user. Accordingly, using object identification techniques in connection with a trained deep learning model (such as detailed above), it can be determined that the hard drive spindle is broken (e.g., even if the device cannot be powered on). Such information can be determined and/or output via a device data listing for the returned device without even powering on the device.

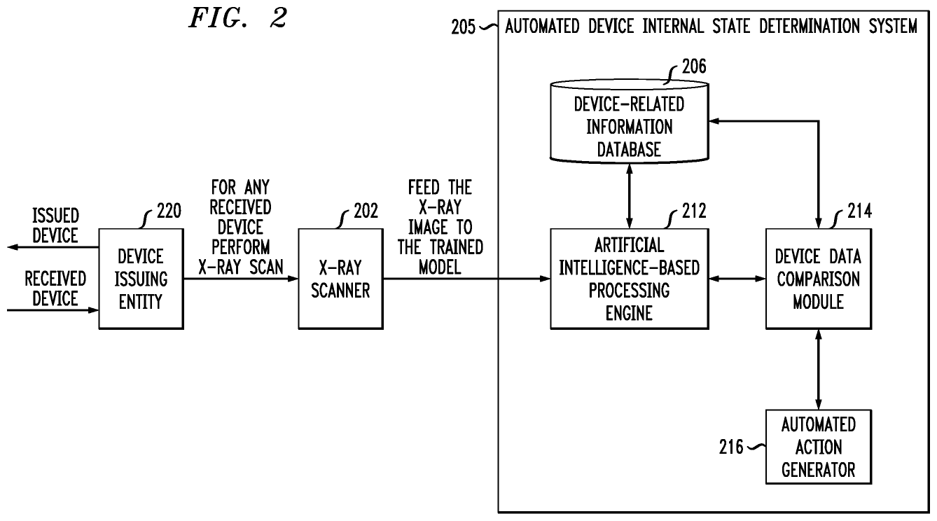

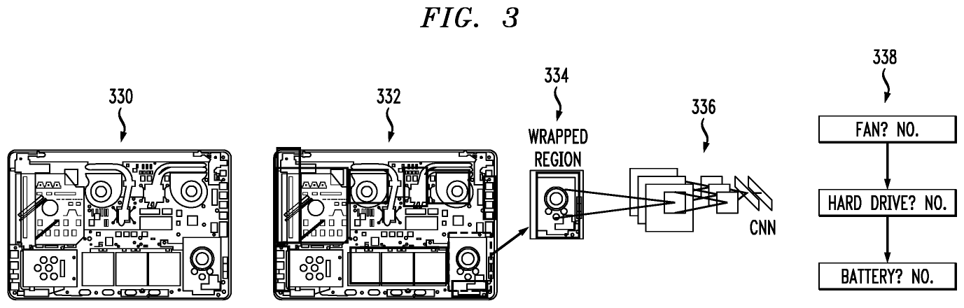

FIG. 2 shows example architecture in an illustrative embodiment. By way of illustration, FIG. 2 depicts device issuing entity 220, which both issues a given device (e.g., to a user) and receives the given device (e.g., returned from the user). Additionally, for any received device via device issuing entity 220, at least one X-ray scan is performed on the device using X-ray scanner 202. As used herein, an X-ray scanner such as element 202 is a device used to build a digital image of a given object (e.g., a device). X-ray scanner 202 uses X-rays to build one or more images and determine the density of various components of the object (e.g., by using X-rays to illuminate an object and analyze one or more properties of the penetrated object according to changes in the transmitted rays). X-ray scanner 202 can emit both high-density rays and low-density rays, and when an object is hit with the high-density rays and low-density rays, at least a portion of the rays are absorbed by the object and the rest of the rays pass through the object. The passed rays are selected by a detector (which is part of X-ray scanner 202) which generates an image based on the differentiation in rays. The generated image is a computer-simulated image that highlights items of various natures (e.g., differentiated by color). By way merely of illustration, example images (of a laptop) are shown in FIG. 3.

Referring again to FIG. 2, X-ray scanner 202 is used to scan a device received by device issuing entity 220 from a user. Once one or more images are generated by the X-ray scanner 202, the one or more images are passed to automated device internal state determination system 205, and more specifically, to the artificial intelligence-based processing engine 212 for image classification and/or object identification.

In one or more embodiments, artificial intelligence-based processing engine 212 comprises a trained R-CNN (which can be trained, for example, in connection with data from device-related information database 206) which is used for object detection in connection with at least one input image. Such object detection can include, for example, locating the presence of one or more objects in connection with at least one bounding box, and identifying one or more types or classes of the located object(s) in an image. Accordingly, artificial intelligence-based processing engine 212 can process input in the form of an image with one or more objects (such as an image generated by X-ray scanner 202), and generate an output including one or more bounding boxes (e.g., defined by at least one point, width, and height) and at least one class label for each bounding box (such as further detailed, for example, in connection with FIG. 3).

As also depicted in FIG. 2, the output(s) generated by artificial intelligence-based processing engine 212 is provided to and/or processed by device data comparison module 214, which compares at least a portion of the output(s) against data derived from device-related information database 206. By comparing the output(s) (which can include, for example, a device data listing of identified components) generated by artificial intelligence-based processing engine 212 to device information (e.g., a device data listing for a pre-shipped version of the same type of device) stored in device-related information database 206, at least one embodiment includes determining and/or identifying one or more missing components in the user-returned device.

Based at least in part on the determination(s) and/or identification(s) made by device data comparison module 214 and output to automated action generator 216, automated action generator 216 can determine at least one root cause associated with the determination(s) and/or identification(s) (e.g., without powering on the device) and/or generating at least one recommendation to an agent of the device issuing entity (e.g., an engineer). By way merely of example, determination of at least one root cause can be based at least in part on the determined and/or identified missing component information. Also, an example recommendation might include the following: out of expected fans f₁, f₂, f₃ and f₄, the second fan (f₂) is missing.

FIG. 3 shows an example R-CNN workflow in an illustrative embodiment. By way of illustration, FIG. 3 depicts an input image 330 (e.g., an X-ray scanner-generated image of a laptop), which is processed by the R-CNN to extract one or more proposed regions in step 332. Step 334 can include determining and/or isolating one or more wrapped regions, and step 336 includes computing one or more CNN features (e.g., device components) associated with the wrapped region(s). In at least one embodiment, implementing an R-CNN includes performing an initial sub-segmentation of one or more input images using one or more graph-based segmentation techniques. Bounding boxes corresponding to at least a portion of the segmented parts are then added to a list of regional proposals, and one or more smaller regions are recursively combined into one or more larger regions based at least in part on similarity. Such steps can be repeated over one or more additional iterations, and on each iteration, bounding box coordinates corresponding to larger segments formed by combining smaller regions are added to the list of region proposals. Subsequently, a final list of x region proposals is determined and/or generated.

As also depicted in FIG. 3, step 338 includes classifying one or more of the regions based at least in part on the one or more computed CNN features (e.g., determining if the one or more regions from the laptop image represent a fan, a hard drive, and/or a battery). In at least one embodiment, the R-CNN is trained by providing input in the form of device component images from different angles, different sizes, etc., and based at least in part thereon, the trained model can classify features as respective components.

As used herein, R-CNNs refer to a family of machine learning models which can be implemented in connection with, for example, computer vision and/or object detection tasks. As noted above, implementing R-CNNs includes determining and/or generating image region proposals, which can be used to localize one or more objects within an image. As also detailed in connection with the example workflow of FIG. 3, an example R-CNN used in one or more embodiments includes a region proposal module, a feature extractor module, and a classifier module. The region proposal module generates and extracts one or more category independent region proposals which can include, for example, one or more candidate bounding boxes. The feature extractor module extracts one or more features from each candidate region, for example, using a deep convolutional neural network. Further, the classifier module classifies the one or more features into one or more predetermined categories, for example, using at least one linear support vector machine (SVM) classifier model.

As detailed herein, to train a deep learning model of the artificial intelligence-based processing engine, at least one embodiment includes preparing and/or obtaining at least one dataset comprising X-ray image data of one or more pre-shipped devices. For each type of device, such an embodiment can include generating at least one X-ray image and using at least a portion of such image data to train the deep learning model (e.g., an R-CNN). Once the deep learning model is trained, it can be implemented to produce lists of items detected in one or more images (e.g., internal state information (such as componentry, connections and/or circuitry) of devices), and such lists can be used as original device data listings for the corresponding types of devices before being shipped to users.

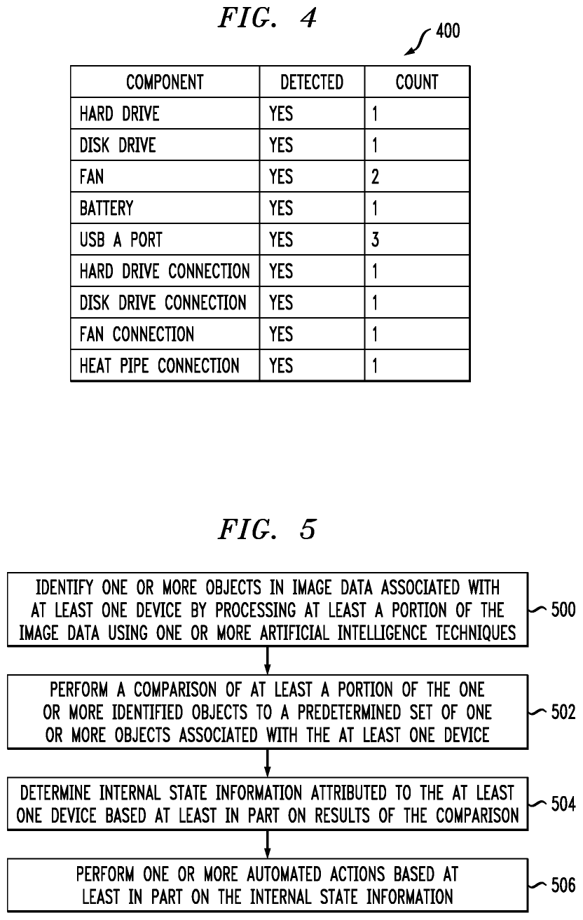

FIG. 4 shows an example table 400 representing device component identification results in an illustrative embodiment. By way of illustration, table 400 depicts at least a portion of the output generated by artificial intelligence-based processing engine (such as element 112 and/or element 212) after processing at least one X-ray image of a given device. Specifically, table 400 illustrates a count of each of multiple components (e.g., hard drive, disk drive, fan battery, USB port, hard drive connection, disk drive connection, fan connection, and heat pipe connection) present in the device (or a similar device type) before being shipping to user, as well as an indication of whether such counts were detected and/or identified by the artificial intelligence-based processing engine in the processed image (e.g., pertaining to the returned device). In one or more embodiments, such a listing of device data as depicted via table 400 can be produced without powering on the device (e.g., the returned device), and such a table can be stored in one or more databases (e.g., device-related information database 106 and/or 206) for future use and/or further processing.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations. For example, one or more of the models described herein may be trained to generate recommendations based at least in part on X-ray image data of given devices and stored internal state data pertaining to similar devices, and such recommendations can be used to initiate one or more automated actions (e.g., automatically initiating one or more device-related repair action, one or more device-related component replacement action, one or more external system communication-related action, etc.).

FIG. 5 is a flow diagram of a process for automatically determining internal state information for devices using artificial intelligence techniques in an illustrative embodiment. It is to be understood that this particular process is only an example, and additional or alternative processes can be carried out in other embodiments.

In this embodiment, the process includes steps 500 through 506. These steps are assumed to be performed by automated device internal state determination system 105 utilizing elements 112, 114 and 116.

Step 500 includes identifying one or more objects in image data associated with at least one device by processing at least a portion of the image data using one or more artificial intelligence techniques. In at least one embodiment, the image data associated with the at least one device includes X-ray image data associated with the at least one device. Also, in one or more embodiments, processing at least a portion of the image data includes processing the at least a portion of the image data using at least one R-CNN. In such an embodiment, processing the at least a portion of the image data using at least one R-CNN includes determining one or more object-related region candidates in the image data using one or more bounding boxes, extracting one or more features from at least a portion of the one or more object-related region candidates using at least one deep convolutional neural network, and classifying at least a portion of the one or more object-related region candidates as at least one predetermined device-related component category by processing at least a portion of the one or more features using at least one linear support vector machine classifier model.

Additionally or alternatively, identifying one or more objects in image data associated with at least one device can include identifying one or more objects in image data associated with at least one device returned by at least one user in connection with one or more device-related issues.

Step 502 includes performing a comparison of at least a portion of the one or more identified objects to a predetermined set of one or more objects associated with the at least one device. In one or more embodiments, performing the comparison includes comparing the at least a portion of the one or more identified objects to a predetermined set of one or more objects present in a pre-shipped version of the at least one device.

Step 504 includes determining internal state information attributed to the at least one device based at least in part on results of the comparison. In at least one embodiment, determining internal state information includes identifying at least one of one or more missing components within the at least one device, one or more misplaced components within the at least one device, one or more missing connections within the at least one device, and one or more misplaced connections within the at least one device.

Step 506 includes performing one or more automated actions based at least in part on the internal state information. In one or more embodiments, performing one or more automated actions includes determining at least one root cause of at least one issue associated with the at least one device based at least in part on the internal state information. Also, in at least one embodiment, performing one or more automated actions includes generating at least one recommendation for one or more responsive actions to be taken in connection with the internal state information. Additionally or alternatively, performing one or more automated actions can include automatically training at least a portion of the one or more artificial intelligence techniques based at least in part on feedback related to the internal state information.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically determine internal state information for devices using artificial intelligence techniques. These and other embodiments can effectively overcome problems associated with resource-intensive and error-prone efforts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

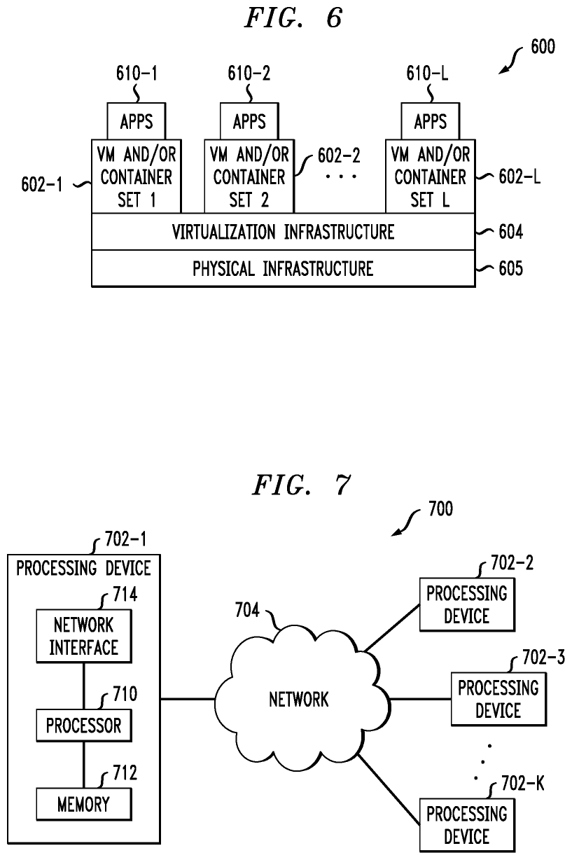

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying one or more objects in image data associated with at least one device by processing at least a portion of the image data using one or more artificial intelligence techniques;
performing a comparison of at least a portion of the one or more identified objects to a predetermined set of one or more objects associated with the at least one device;
determining internal state information attributed to the at least one device based at least in part on results of the comparison; and
performing one or more automated actions based at least in part on the internal state information;
wherein the method is performed by at least one processing device comprising a processor coupled to a memory.

2. The computer-implemented method of claim 1, wherein the image data associated with the at least one device comprises X-ray image data associated with the at least one device.

3. The computer-implemented method of claim 1, wherein performing the comparison comprises comparing the at least a portion of the one or more identified objects to a predetermined set of one or more objects present in a pre-shipped version of the at least one device.

4. The computer-implemented method of claim 1, wherein processing at least a portion of the image data comprises processing the at least a portion of the image data using at least one region-based convolutional neural network.

5. The computer-implemented method of claim 4, wherein processing the at least a portion of the image data using at least one region-based convolutional neural network comprises determining one or more object-related region candidates in the image data using one or more bounding boxes.

6. The computer-implemented method of claim 5, wherein processing the at least a portion of the image data using at least one region-based convolutional neural network comprises extracting one or more features from at least a portion of the one or more object-related region candidates using at least one deep convolutional neural network.

7. The computer-implemented method of claim 6, wherein processing the at least a portion of the image data using at least one region-based convolutional neural network comprises classifying at least a portion of the one or more object-related region candidates as at least one predetermined device-related component category by processing at least a portion of the one or more features using at least one linear support vector machine classifier model.

8. The computer-implemented method of claim 1, wherein identifying one or more objects in image data associated with at least one device comprises identifying one or more objects in image data associated with at least one device returned by at least one user in connection with one or more device-related issues.

9. The computer-implemented method of claim 1, wherein determining internal state information comprises identifying at least one of one or more missing components within the at least one device, one or more misplaced components within the at least one device, one or more missing connections within the at least one device, and one or more misplaced connections within the at least one device.

10. The computer-implemented method of claim 1, wherein performing one or more automated actions comprises determining at least one root cause of at least one issue associated with the at least one device based at least in part on the internal state information.

11. The computer-implemented method of claim 1, wherein performing one or more automated actions comprises generating at least one recommendation for one or more responsive actions to be taken in connection with the internal state information.

12. The computer-implemented method of claim 1, wherein performing one or more automated actions comprises automatically training at least a portion of the one or more artificial intelligence techniques based at least in part on feedback related to the internal state information.

13. A non-transitory processor-readable storage medium having stored therein program code of one or more software programs, wherein the program code when executed by at least one processing device causes the at least one processing device:
to identify one or more objects in image data associated with at least one device by processing at least a portion of the image data using one or more artificial intelligence techniques;
to perform a comparison of at least a portion of the one or more identified objects to a predetermined set of one or more objects associated with the at least one device;
to determine internal state information attributed to the at least one device based at least in part on results of the comparison; and
to perform one or more automated actions based at least in part on the internal state information.

14. The non-transitory processor-readable storage medium of claim 13, wherein the image data associated with the at least one device comprises X-ray image data associated with the at least one device.

15. The non-transitory processor-readable storage medium of claim 13, wherein performing the comparison comprises comparing the at least a portion of the one or more identified objects to a predetermined set of one or more objects present in a pre-shipped version of the at least one device.

16. The non-transitory processor-readable storage medium of claim 13, wherein processing at least a portion of the image data comprises processing the at least a portion of the image data using at least one region-based convolutional neural network.

17. An apparatus comprising:
at least one processing device comprising a processor coupled to a memory;
the at least one processing device being configured:
to identify one or more objects in image data associated with at least one device by processing at least a portion of the image data using one or more artificial intelligence techniques;
to perform a comparison of at least a portion of the one or more identified objects to a predetermined set of one or more objects associated with the at least one device;
to determine internal state information attributed to the at least one device based at least in part on results of the comparison; and
to perform one or more automated actions based at least in part on the internal state information.

18. The apparatus of claim 17, wherein the image data associated with the at least one device comprises X-ray image data associated with the at least one device.

19. The apparatus of claim 17, wherein performing the comparison comprises comparing the at least a portion of the one or more identified objects to a predetermined set of one or more objects present in a pre-shipped version of the at least one device.

20. The apparatus of claim 17, wherein processing at least a portion of the image data comprises processing the at least a portion of the image data using at least one region-based convolutional neural network.
